(19) United States
(12) Patent Application Publication
(10) Pub. No.: US 2017/0066463 A1
(43) Pub. Date: Mar. 9, 2017

(54) FOLDABLE TRUCK

(71) Applicant: Wei-Ming Wang, New Taipei City (TW)

(72) Inventors: Wei-Ming Wang, New Taipei City (TW); Shih-Hsien Chen, New Taipei City (TW)

(73) Assignee: Wei-Ming Wang

(21) Appl. No.: 15/093,792

(22) Filed: Apr. 8, 2016

(30) Foreign Application Priority Data
Sep. 8, 2015 (CN) 201520690213.1

(51) Int. Cl. B62B 3/02; B62B 5/06; B62B 3/04

(52) U.S. Cl. CPC B62B 3/022; B62B 3/04; B62B 5/06

(57) ABSTRACT

The foldable truck includes a carrier, a retractable frame and a handle pole. The carrier has a first platform and a second platform connected thereto. The first platform is provided with two front wheels. The second platform is provided with a rod slidably mounted by two rear wheels. The retractable frame has two first retractable frames, two second retractable frames, a third retractable frame and a fourth retractable frame. The handle pole has a first end formed into a handle and a second end rotatably connected to the third retractable frame.

### BACKGROUND OF THE INVENTION

1. Technical Field The invention relates to wheeled platforms for conveying loads, particularly to foldable trucks.

2. Related Art

To convey loads, people usually use a wheeled platform, also known as truck, which is provided with two or four wheels. A two-wheel truck is very light and compact, but the loads it can carry are limited in weight and volume. Contrarily, a four-wheel truck can carry relatively larger and heavier loads, but it is bulky and hard to be conveyed or stored.

Taiwan patent No. M411373 discloses a two-wheel truck. This truck is provided with a removable bag, which can be used individually. In other words, this truck can be used with or without the bag. However, it still has inherent drawbacks of two-wheel truck as abovementioned.

Taiwan patent No. I289124 discloses a retractable truck. This truck includes a framework, a wheel set and a positioning mechanism. The framework has a main frame, a front portion, a front wheel frame, a front support, a rear support and a connection frame. The positioning mechanism can position the front and rear supports and the connection frame to be erected on the main frame or release them to retract. However, in this truck, the main frame separately connects a front wheel and two rear wheels to form a larger loading space, but its folded volume is still not small enough to be conveniently conveyed or stored.

### SUMMARY OF THE INVENTION

An object of the invention is to provide a foldable truck, which can be retracted to be very compact, so that it can be easy to be conveyed or stored.

To accomplish the above object, the foldable truck of the invention includes a carrier, a retractable frame and a handle pole. The carrier has a first platform and a second platform. A first end of the first platform is rotatably connected to a first end of the second platform. A second end of the first platform is provided with two front wheels. A receiving space is formed between the two front wheels. A second end of the second platform is provided with a rod. The rod is slidably mounted by two rear wheels. The retractable frame has two first retractable frames, two second retractable frames, a third retractable frame and a fourth retractable frame. Each first retractable frame is rotatably connected to the second end of the first platform. The second end of each second retractable frame is rotatably connected to the second end of the second platform. The third retractable frame is rotatably connected to the first retractable frames. Two ends of the fourth retractable frame are separately rotatably connected to the second retractable frame and two ends of the third retractable frames. A handle pole has a first end formed into a handle and a second end rotatably connected to the third retractable frame.

### BRIEF DESCRIPTION OF THE DRAWINGS

FIG. 1 is a perspective view of the invention;

FIGS. 2A and 2B are two schematic views of the invention in an expanded status and a retracted status, respectively;

FIGS. 3A and 3B are another two schematic views of the invention in an expanded status and a retracted status, respectively;

FIG. 4 is a schematic view of the invention in a retracted status;

FIG. 5 is an enlarged view of the front wheel of the invention;

FIG. 6 is an enlarged view of the rear wheel of the invention;

FIG. 7 is a schematic view of the rotatable connection of the invention; and

FIGS. 8A and 8B are two schematic views of the invention with a container.

### DETAILED DESCRIPTION OF THE INVENTION

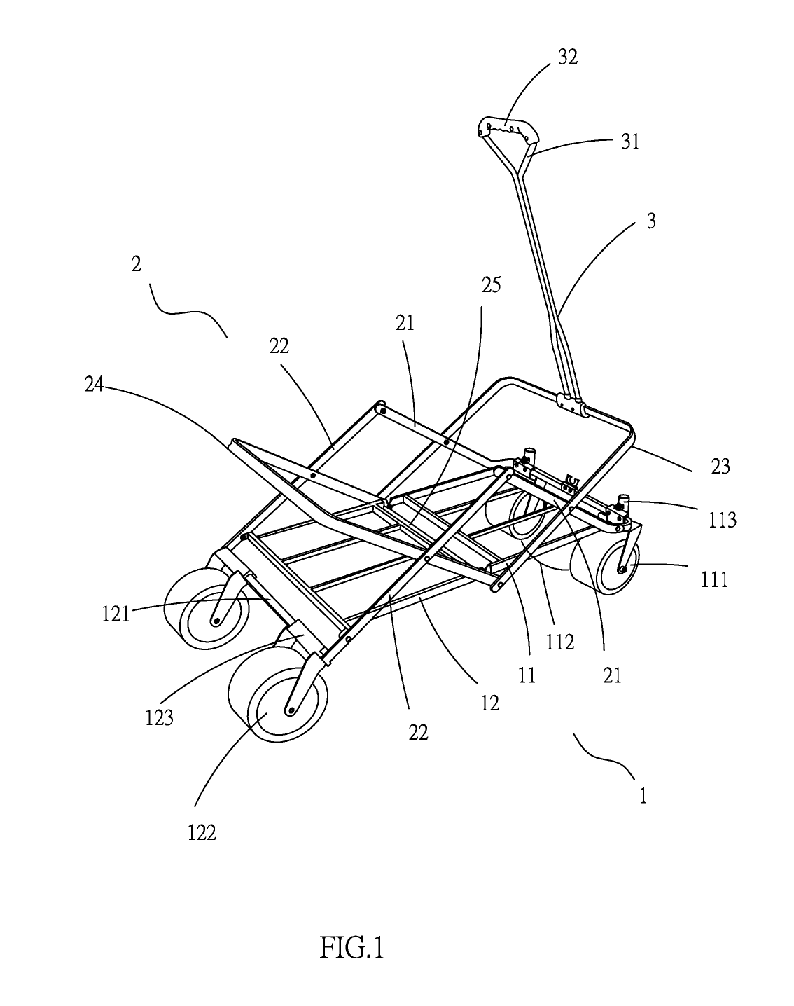

Please refer to FIG. 1. The foldable truck of the invention includes a carrier 1, a retractable frame 2 and a handle pole 3.

The carrier 1 includes a first platform 11 and a second platform 12, which are made of metal or plastic. A first end of the first platform 11 is rotatably connected to a first end of the second platform 12. In other words, the first platform 11 and the second platform 12 can be bent against each other to be of a vee shape. A second end of the first platform 11 is provided with two front wheels 111. In this embodiment, the front wheels 111 are provided with bearings 113 to be horizontally rotatably for steering. A receiving space 112 is formed between the two front wheels 111. A second end of the second platform 12 is provided with a rod 121. The rod 121 is slidably mounted by two rear wheels 122. Each of the rear wheels 122 is provided with a sleeve 123 for sliding on the rod 121.

The retractable frame 2 has two first retractable frames 21, two second retractable frames 22, a third retractable frame 23 and a fourth retractable frame 24, which are made of plastic or metal. Each first retractable frame 21 is rotatably connected to the second end of the first platform 11. The second end of each second retractable frame 22 is rotatably connected to the second end of the second platform 12. The third retractable frame 23 is rotatably connected to the first retractable frames 21. Two ends of the fourth retractable frame 24 are separately rotatably connected to the second retractable frame 22 and two ends of the third retractable frames 23.

Each of the third retractable frames 23 and the fourth retractable frames 24 is formed into a U-shape, but other shapes are also available. A connecting rod 25 is connected between the two junctions of the fourth retractable frames 24 and the third retractable frames 23.

The handle pole 3 has a first end 31 formed into a handle 31 and a second end rotatably connected to the third retractable frame 23. The handle 31 is further provided with a grip 32.

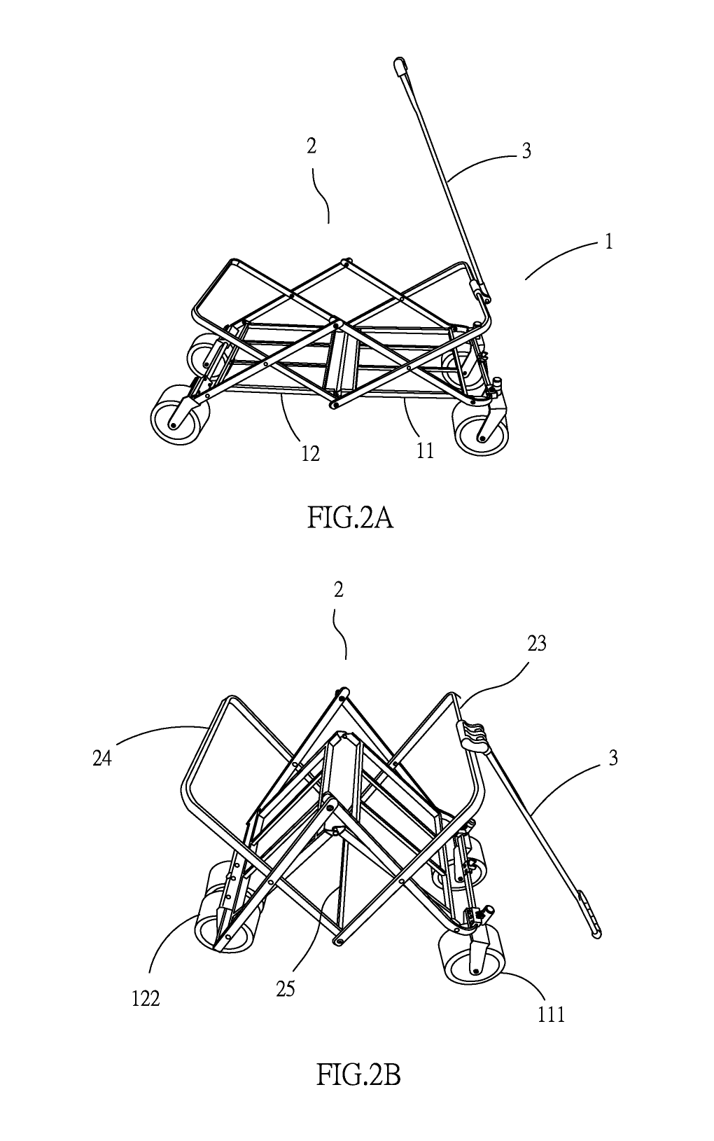

Please refer to FIGS. 2A and 2B. When a user wants to retract the truck of the invention, he or she only needs to push the two rear wheels 122 from two ends to the center and to bend the first and second platforms 11, 12 into a vee shape. In the meantime, the first retractable frames 21, the second retractable frames 22, the third retractable frame 23 and the fourth retractable frame 24 are correspondingly retracted. Finally, downward rotate the handle pole 3 to finish the retraction procedure. The truck may be expanded by a reverse order.

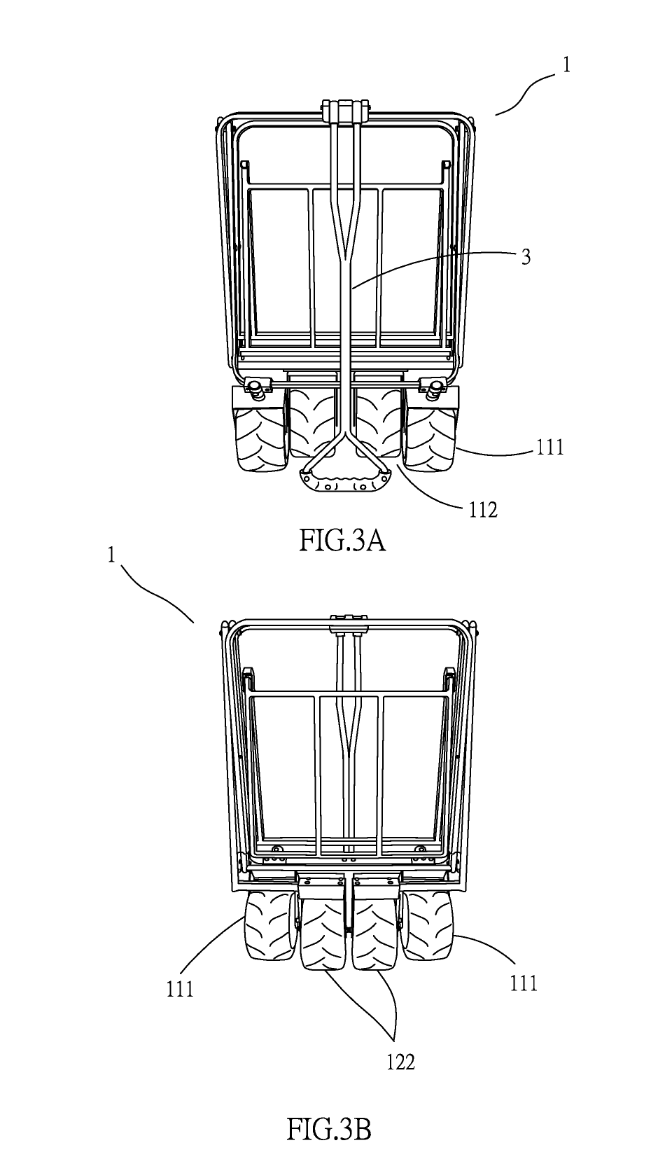

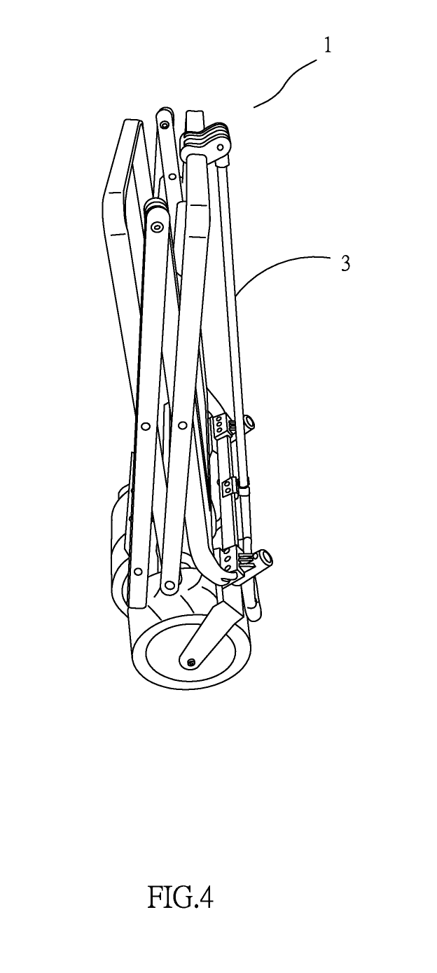

Please refer to FIGS. 3A, 3B and 4. Because of the receiving space 112 between the two front wheels 111, the rear wheels 122 can be pushed into the receiving space 112 to shrink the overall volume.

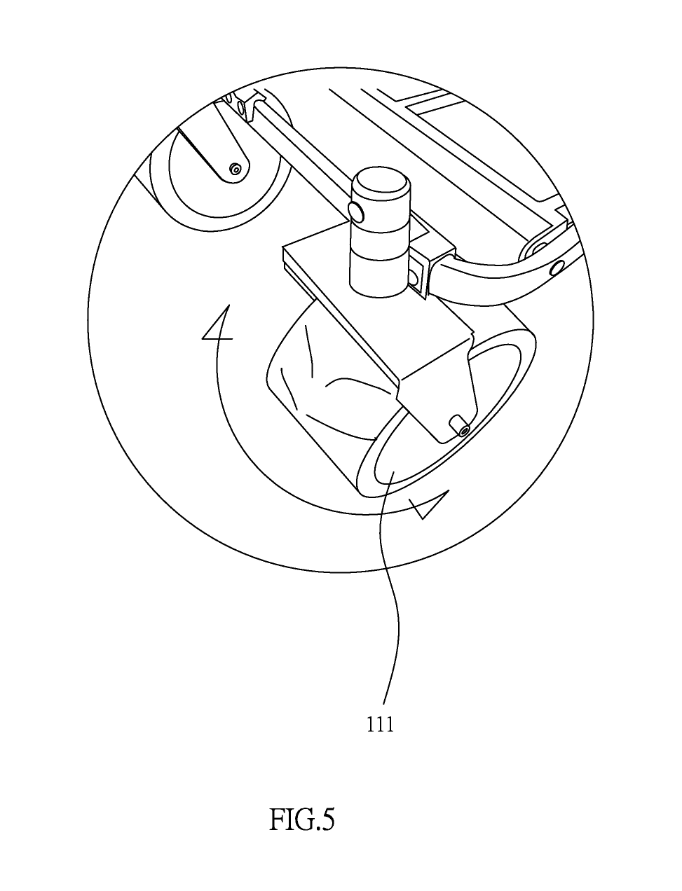

Please refer to FIG. 5. Each of the front wheels 111 is provided with a bearing 113 for steering.

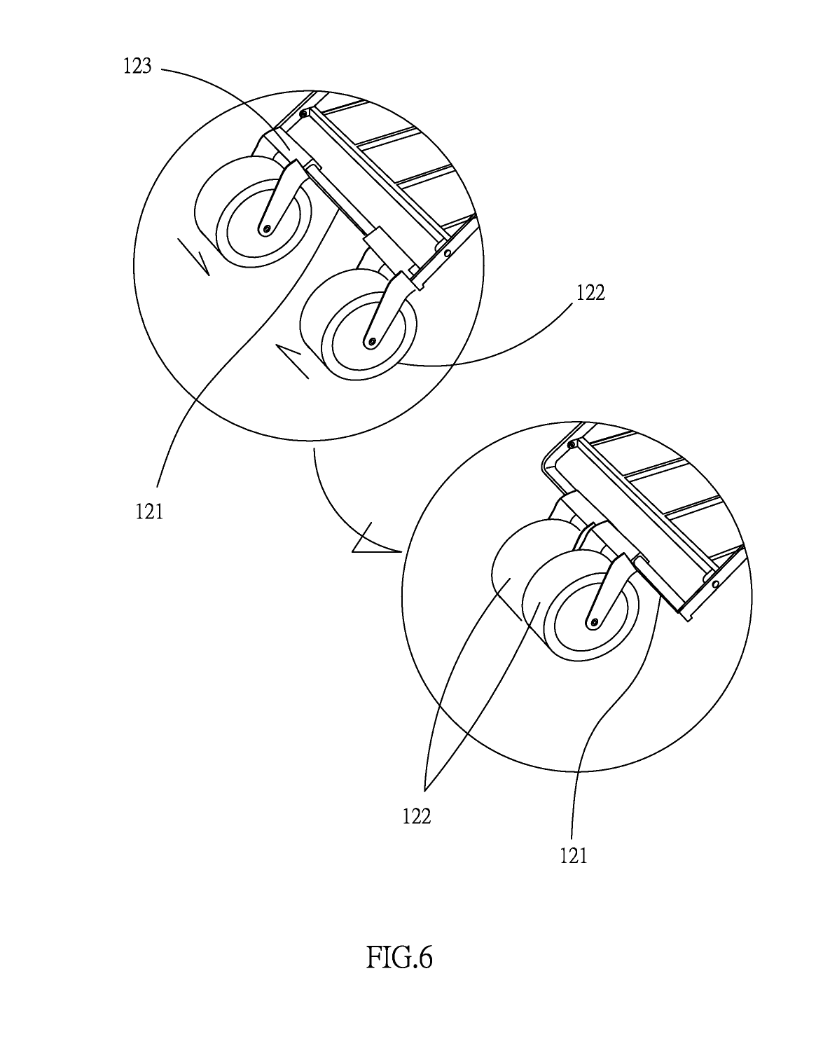

Please refer to FIG. 6. A second end of the second platform 12 is provided with a rod 121. The rod 121 is slidably mounted by two rear wheels 122. Each of the rear wheels 122 is provided with a sleeve 123 for sliding on the rod 121. The rod 121 may be formed into an oval shape but other shapes are also available. Proper friction is generated between the sleeve 123 and the rod 121 to prevent the rear wheels 122 from undesiredly sliding.

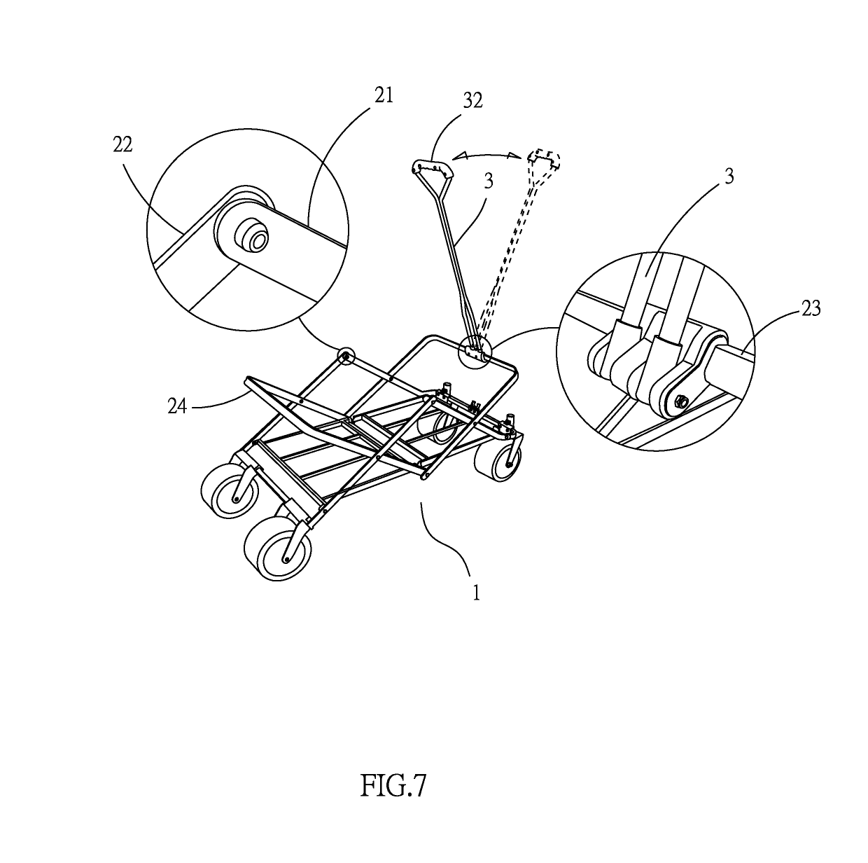

Please refer to FIG. 7, which shows rotatable connections used in the invention. For example, a pin, spindle or pivot is available. Also, the handle pole 3 can be freely adjusted to any desired position.

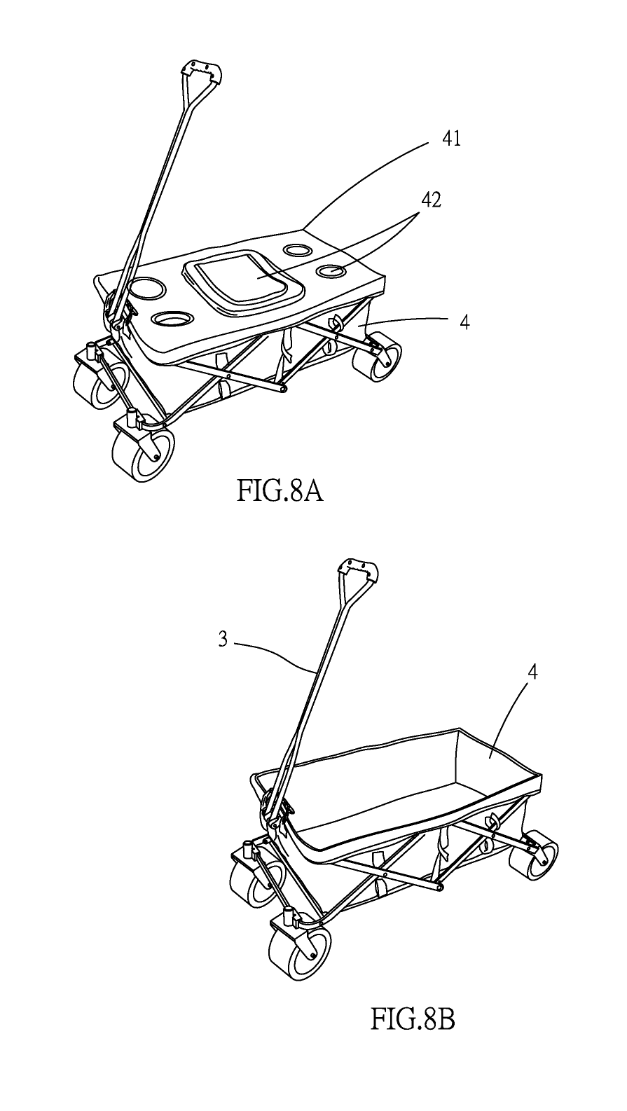

Please refer to FIGS. 8A and 8B. A container 4 may be optionally added on the carrier 1. The container 4 may be made of paper, fabric or plastic. The container 4 may be further provided with a cover 41 with bags 42.

It will be appreciated by persons skilled in the art that the above embodiment has been described by way of example only and not in any limitative sense, and that various alterations and modifications are possible without departure from the scope of the invention as defined by the appended claims.

What is claimed is:

1. A foldable truck comprising:
a carrier, comprising a first platform and a second platform, a first end of the first platform being rotatably connected to a first end of the second platform, a second end of the first platform being provided with two front wheels, a receiving space being formed between the two front wheels, a second end of the second platform being provided with a rod, and the rod being slidably mounted by two rear wheels;
a retractable frame, comprising two first retractable frames, two second retractable frames, a third retractable frame and a fourth retractable frame, each first retractable frame being rotatably connected to the second end of the first platform, the second end of each second retractable frame being rotatably connected to the second end of the second platform, the third retractable frame being rotatably connected to the first retractable frames, two ends of the fourth retractable frame being separately rotatably connected to the second retractable frame and two ends of the third retractable frames; and
a handle pole, having a first end formed into a handle and a second end rotatably connected to the third retractable frame.

2. The foldable truck of claim 1, wherein the front wheels are horizontally rotatable.

3. The foldable truck of claim 2, wherein each front wheel is provided with a bearing.

4. The foldable truck of claim 1, wherein each of the rear wheels is provided with a sleeve for sliding on the rod.

5. The foldable truck of claim 1, wherein the handle is provided with a grip.

6. The foldable truck of claim 1, further comprising a connecting rod connected between two junctions of the fourth retractable frames and the third retractable frames.

7. The foldable truck of claim 1, further comprising a container on the carrier.

8. The foldable truck of claim 7, wherein the container is provided with a cover.

9. The foldable truck of claim 8, wherein the cover is provided with at least one bag.
